(19) United States
(12) Patent Application Publication
(10) Pub. No.: US 2003/0046341 A1
(43) Pub. Date: Mar. 6, 2003

(54) Server for controlling control object apparatus on client demand

(76) Inventor: Ryuzo Fujita, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/043,765

(22) Filed: Jan. 10, 2002

(30) Foreign Application Priority Data
Sep. 4, 2001 (JP) 2001-267780

(51) Int. Cl. G06F 15/16

(52) U.S. Cl. 709/203; 709/227

(57) ABSTRACT

A server for controlling a controlled apparatus, serving as a control object, in accordance with a request received from a client, includes a database, a control-state-saving unit for saving control information relevant to the request received from the client in the database; a job-continuing unit for continuing a job of controlling the controlled apparatus on the basis of the control information, which is relevant to the request received from the client and is saved in the database, a job-data-saving unit for saving response data received from the controlled apparatus as a result of the job continued by the job-continuing unit in the database by associating the response data with the control information saved in the database, and a data-recovering unit for creating a recovery message to be transmitted to the client on the basis of the control information, which is relevant to the request received from the client and is saved in the database, and on the basis of the response data saved in the database and associated with the control information.

### BACKGROUND OF THE INVENTION

1. Field of the Invention

The present invention relates to a server for controlling an apparatus serving as a control object on the basis of a demand received from a client and relates to a client-server system.

2. Description of the Related Art

When a failure such as a line breakage or frequent generation of errors caused by noises occurs in a transmission apparatus composing a communication network, a transmission line of the network becomes abnormal. In order to secure a transmission line through another route as a substitute for the abnormal transmission line, a control job such as line-switching control is carried out for the transmission apparatus. Then, the transmissibility and the communication quality of the transmission line that once became abnormal are examined to identify and eliminate the failure so as to recover the line. In particular, test control is executed on specific transmission apparatuses connected to each other by the abnormal transmission line in the communication network. One of the specific transmission apparatuses is driven to output a test pattern. The other specific transmission apparatus returns a reflected pattern. Then, the pattern-transmitting specific transmission apparatus compares the test pattern with the reflected pattern, evaluating the transmissibility and the communication quality of the transmission line for a period of time ranging from several minutes to several months. That is to say, in general, it takes several minutes to isolate the failure but several months to assure the communication quality of the transmission line. The test control is executed by a client-server system comprising a client, a server and a plurality of transmission apparatuses.

FIG. 19 is a diagram showing the configuration of the conventional client-server system. As shown in FIG. 19, the client-server system comprises a client 2, servers 4#i where i=A, B and so on and transmission apparatuses 6#ij where i=A, B and so on and j=1,2 and so on. FIG. 20 is a functional block diagram showing the client 2 and the server 4#i. As shown in FIG. 20, the client 2 comprises a screen-display unit 10, a processing unit 12 and a transmission/reception unit 14. On the other hand, the server 4#i comprises a transmission/reception unit 20, a connection-management unit 22 and a job-executing unit 24. As indicated by an arrow (1), the screen-display unit 10 receives data required for control in accordance with screen control. In the client 2, the data received by the screen-display unit 10 in accordance with the screen control is processed internally by the processing unit 12. A result of processing is transmitted to the server 4#i as indicated by an arrow (2). The transmission/reception unit 20 employed in the server 4#i passes on the data received from the client 2 to the job-executing unit 24 by way of the connection-management unit 22. The job-executing unit 24 converts the data received from the client 2 into data with a format suitable for the transmission apparatus 6#ij, which serves as an object of control. The data with a format suitable for the transmission apparatus 6#ij is then transmitted to the transmission apparatus 6#ij as indicated by an arrow (3).

The transmission apparatus 6#ij executes control based on the data received from the server 4#i and transmits a test result to the job-executing unit 24 employed in the server 4#i as indicated by an arrow (4). The job-executing unit 24 converts the test result into data with a format proper for the client 2 and transmits the data to the client 2 by way of the connection-management unit 22 and the transmission/reception unit 20 as indicated by an arrow (5). In the client 2, the processing unit 12 analyzes the data received from the server 4#i and displays a result of the control on the screen-display unit 10. The result of the control can be viewed by the user as indicated by an arrow (6).

As shown by a double-line arrow (7), the connection-management unit 22 diagnoses communications between the client 2 and the server 4#i and, when the screen-display of the client 2 is terminated at the end of a communication session between the client 2 and the server 4#i, the connection-management unit 22 also terminates the operation of the job-executing unit 24 employed in the server 4#i. In addition, in the event of an abnormal termination, the server 4#i detects the abnormal termination of the client 2 on the basis of a diagnosis result. In this case, the connection-management unit 22 also terminates the operation of the job-executing unit 24.

A transmissibility-test sequence is explained on the basis of the operations described above as follows. FIG. 21 shows sequence charts of the transmissibility test conducted in the conventional system. By using the screen, the operator enters a command for requesting the client 2 to start the test. The client 2 requests the transmission apparatus 6#ij to start the test through the server 4#i. Receiving a command to start the test, the transmission apparatus 6#ij connects a test circuit to a transmission line and inserts a test signal. The transmission apparatus 6#ij informs the client 2 of a result of the test through the server 4#i. The client 2 displays the response result received from the server 4#i on the screen.

Then, the operator requests the client 2 to start the test corresponding to the response result displayed on the screen. The client 2 requests the transmission apparatus 6#ij to start measurement through the server 4#i. Receiving a command to start measurement, the transmission apparatus 6#ij informs the client 2 of a result of the measurement through the server 4#i. The client 2 displays the measurement results received from the server 4#i on the screen.

Then, the operator may request manual collection of measurement results. In this case, the operator enters a command for requesting the client 2 to collect results of measurement. The client 2 requests the transmission apparatus 6#ij to collect results of measurement through the server 4#i. Receiving a command to collect results of measurement, the transmission apparatus 6#ij collects results of measurement. The transmission apparatus 6#ij informs the client 2 of a result of the measurement-result collection through the server 4#i. The client 2 displays the measurement results received from the server 4#i on the screen. In this way, each time such a command is entered by the operator, results of measurement are displayed on the screen.

As an alternative, the operator may also request automatic collection of measurement results. In this case, the operator enters a command for requesting the client 2 to automatically collect results of measurement. The client 2 requests the transmission apparatus 6#ij to collect results of measurement through the server 4#i. Receiving a command to collect results of measurement, the transmission apparatus 6#ij collects results of measurement. The transmission apparatus 6#ij informs the client 2 of a result of the measurement-result collection through the server 4#i. The client 2 displays the measurement results received from the server 4#i on the screen. In this way, once such a command is entered by the operator, the operations to collect measurement results and display them on the screen are carried out repeatedly at a predetermined period.

The test is ended as follows. The client 2 requests the transmission apparatus 6#ij through the server 4#i to end measurements and the test. Receiving a command to end measurements and the test, the transmission apparatus 6#ij disconnects the test circuit and discontinues the operation to insert the test signal. Then, the transmission apparatus 6#ij informs the client 2 of a result of the termination through the server 4#i. The client 2 displays the result of the termination on the screen.

The client-server system employs a dedicated terminal capable of continuously operating for 24 hours a day and 365 days a year as the client 2. In addition, the client 2 can be used for developing a screen application peculiarly to the system in a continuously operable form. Furthermore, a plurality of clients 2 can be connected to a server 4#i.

The probability of communication abnormality occurrence between a client 2 and the server 4#i is extremely low. With the present state of the art, there occur almost no communication abnormalities except physical failures such as a LAN abnormality. One of characteristics of the client-server system is that, as a control job, control is executed always in accordance with a command entered from the client 2. Normally, the operator sets necessary information via the client 2 and accomplishes the control job while verifying responses displayed on the screen. Thus, as described above, when jobs such as an operation to collect measurement results are activated to be carried out continuously, the operator enters a command for the jobs to be carried out automatically via the client 2 and can have the jobs done while verifying information appearing on the screen-display unit 10. Such a command can be regarded as a trigger activated manually and then repeated continuously. If it takes a long time to execute job, the job can be represented by an icon that can be clicked by the operator at any time when the operator wants to activate the job or verify collected test results. When a session between the client 2 and the server 4#i is discontinued, the control job is terminated. This is because all kinds of control are triggered from the client 2 so that, in the event of a session abnormality, the control job cannot be continued.

When a dedicated terminal is used as the client 2, however, the following problems are raised.

1: It is the client that has information on activation of a job, and the server does not have such information. Thus, when a control job is carried out by entering a command via a particular terminal, only the particular terminal can be used for verifying results and continuing the control job.

2: When a screen is terminated, all control jobs must also be ended and another terminal cannot be used for continuing the control jobs.

3: In the case of a control job requiring that the terminal be connected to the server for a long time, a connection abnormality of the client inevitably terminates the control job.

4: A command to terminate a test is issued by the operator, but such a command is not transmitted to the transmission apparatus in the event of an abnormality occurring between the client and the server in spite of the fact that such an abnormality inevitably terminates the control job. As a result, the transmission apparatus remains in a controlled state as it is. Since the transmission line of the transmission apparatus also remains in a controlled state as well, the transmission line cannot be put in an operating state.

In recent years, the Internet and mobile phones have becoming very popular and the amount of information communicated through the Internet and the mobile phones also increases as well. The communicated information includes color pictures and moving pictures. For this reason, people involved in communication businesses strive to expand communication networks and make the networks more powerful. In consequence, the number of apparatuses composing a communication network also increases rapidly, making the network itself complicated. In addition, a control terminal for controlling an apparatus composing a communication network is not a dedicated terminal. Instead, by employing a PC (personal computer) as a client using the Internet, the client can be implemented at a low cost, making it possible to provide a system controllable from a plurality of clients installed at all stations. In such a system, if an abnormal connection between a client and a server is detected in the course of a control job, as processing to handle the abnormality, the server terminates the control job. Thus, as a daily matter in the event of a detected abnormality, the user can see circumstances such as a locked state of information displayed on a screen of the client and discontinuation of the PC operation upon termination of a control job. Thus, when a PC is used as a client in accordance with the conventional system, the following problems are raised in the course of a job to control the network and bring about big hindrances to the job.

1: Since all control information for a control job is held in the client, the same control job cannot be carried out from another terminal unless the control job being currently executed is terminated. That is, it is impossible to take the result at another location while continuing a control job.

2: Since operating conditions of a PC do not support a 24-hour continuous operation, there is resulted in a circumstance in which a long-time measurement such as a test control job cannot be carried out.

3: In the event of an abnormality of communication between the client and the server, an operation to supply information from the client to the server is discontinued so that the control job must inevitably be ended. In such a circumstance, control results cannot be obtained, execution of the control cannot be continued and even termination processing cannot be carried out. Thus, the transmission apparatus unavoidably remains in a state of controlling a test as it is. In such a state, the transmission apparatus cannot be put in an operating state. Thus, when another screen is resumed, for a point with test control implemented, it is necessary to execute control for terminating the test.

4: Since a PC is provided with numerous and various kinds of software, the storage capacity of a memory usable for a control job is limited when seen from the terminal-resource point of view so that a plurality of screens cannot be opened at the same time. As a result, restrictions are imposed on reliability and performance of the client.

5: When control is executed in parallel to the software of numerous and various kinds and an abnormality occurs in software other than a monitoring control screen, the terminal is reactivated. Thus, the communication between the terminal and the server is once terminated inevitably, making it no longer possible to collect results of measurement. In addition, a resumed screen displayed previously must be set at the same parameters as before.

### SUMMARY OF THE INVENTION

It is therefore an object of the present invention to provide a server capable of continuing a transmission-apparatus control job requested by a client even in the event of a client job termination, recovering data relevant to the transmission-apparatus control job and supplying the data to the client, and provide a client-server system employing such a server.

In accordance with an aspect of the present invention, there is provided a server for controlling a controlled apparatus, serving as a control object, in accordance with a request received from a client, includes: a database; a control-state-saving unit for saving control information relevant to the request received from the client in the database; a job-continuing unit for continuing a job of controlling the controlled-apparatus on the basis of the control information, which is relevant to the request received from the client and is saved in the database; a job-data-saving unit for saving response data received from the controlled apparatus as a result of the job continued by the job-continuing unit in the database by associating the response data with the control information saved in the database; and a data-recovering unit for creating a recovery message to be transmitted to the client on the basis of the control information, which is relevant to the request received from the client and is saved in the database, and on the basis of the response data saved in the database and associated with the control information.

In accordance with another aspect of the present invention, there is provided a client-server system including a client and a server. The client-server system is characterized in that: the client includes: a test-control-requesting unit for transmitting control information relevant to test control to the server; a tentative-termination-requesting unit for transmitting a request for a tentative termination of the test control to the server; and a resumption-requesting unit for transmitting a request for a resumption of the test control to the server, whereas the server includes: a database; a control-state-saving unit for saving control information relevant to the request received from the client in the database; a job-continuing unit for continuing a job of controlling a controlled apparatus, serving as a control object, on the basis of the control information, which is relevant to the request received from the client and is saved in the database; a job-data-saving unit for saving response data received from the controlled apparatus as a result of the job continued by the job-continuing unit in the database by associating the response data with the control information saved in the database; and a recovered-data-transmitting unit for creating a recovery message to be transmitted to the client on the basis of the control information, which is relevant to the request received from the client and is saved in the database, and on the basis of the response data saved in the database and associated with the control information.

The present and other objects, features and advantages of the present invention as well as the manner of realizing them will become more apparent, whereas the invention itself will be best understood from a study of the following description and appended claims with reference to attached drawings showing some preferred embodiments of the invention.

### BRIEF DESCRIPTION OF THE DRAWINGS

FIG. 1 is a block diagram showing the principle of the present invention;

FIG. 2 is a block diagram showing the configuration of a client-server system implemented by an embodiment of the present invention;

FIG. 3 is a block diagram showing the configuration of a client and a server, which are employed in the client-server system shown in FIG. 2;

FIG. 4 is a diagram showing the configuration of a database employed in the server of the client-server system shown in FIG. 3;

FIG. 5 is a diagram showing a typical network connection management initial screen;

FIG. 6A is a diagram showing the configuration of a low-level menu of a network-management menu button displayed on the typical network connection management initial screen shown in FIG. 5;

FIG. 6B is a diagram showing the configuration of a low-level menu of a configuration-control menu button displayed on the typical network connection management initial screen shown in FIG. 5;

FIG. 6C is a diagram showing the configuration of a low-level menu of an information-search menu button displayed on the typical network connection management initial screen shown in FIG. 5;

FIG. 6D is a diagram showing the configuration of a low-level menu of a utility menu button displayed on the typical network connection management initial screen shown in FIG. 5;

FIG. 7 is a diagram showing a typical test control screen;

FIG. 8 is a diagram showing a typical path test control screen;

FIG. 9 is a diagram showing flows of processing for a normal-connection case;

FIG. 10 is a sequence chart of a test for an abnormal-connection case;

FIG. 11 is a diagram showing flows of processing for an abnormal-connection case;

FIG. 12 is a sequence chart for a tentative termination case;

FIG. 13 is a diagram showing flows of processing for a tentative termination case;

FIG. 14 is a sequence chart for a resumption;

FIG. 15 is a diagram showing flows of processing of a request for a list;

FIG. 16 is a diagram showing a tentative termination processing screen;

FIG. 17 is a diagram showing flows of processing to select an item from the list;

FIG. 18 is a diagram showing a typical display screen showing the list;

FIG. 19 is a block diagram showing the configuration of the conventional client-server system;

FIG. 20 is a block diagram showing the configuration of a sever employed in the conventional client-server system shown in FIG. 19; and

FIG. 21 is a sequence chart of a test conducted in the conventional client-server system.

### DETAILED DESCRIPTION OF THE PREFERRED EMBODIMENTS

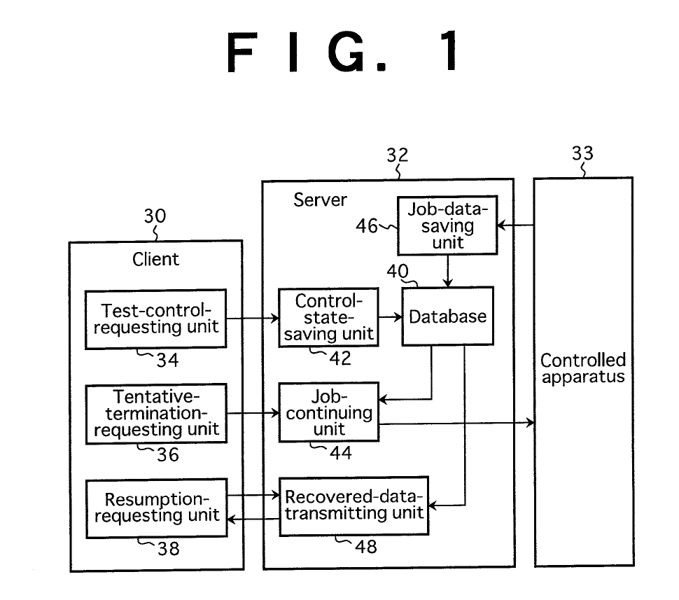

Before explaining embodiments of the present invention, the principle of the invention is described. FIG. 1 is a block diagram showing the principle of the present invention. As shown in the figure, a client-server system comprises a client 30 and a server 32. The client 30 comprises a test-control-requesting unit 34, a tentative-termination-requesting unit 36 and a resumption-requesting unit 38. On the other hand, the server 32 comprises a database 40, a control-state-saving unit 42, a job-continuing unit 44, a job-data-saving unit 46 and a recovered-data-transmitting unit 48.

The test-control-requesting unit 34 transmits control information relevant to test control to the server 32. The control-state-saving unit 42 receives the control information relevant to test control from the client 30 and saves the information in the database 40. The control information saved in the database 40 is information required for continuing the test control. The tentative-termination-requesting unit 36 issues a request for a tentative termination of test control to the server 32 in order to temporarily end a job. When receiving a request for a tentative termination from the client 30, the job-continuing unit 44 employed in the server 32 controls a controlled apparatus 33, serving as a control object, to actually continue a test based on control information, which is relevant to the test control and stored in the database 40. The job-data-saving unit 46 saves response data received from the controlled apparatus 33 in the database 40 by associating the response data with the control information. The response data is generated by the controlled apparatus 33 as a result of execution of the test control by the job-continuing unit 44 on the controlled apparatus 33. Thus, even if a job is temporarily terminated, the server 32 continues executing test control on the controlled apparatus 33 and stores response data received as a result of execution of the test control in the database 40. The resumption-requesting unit 38 requests the server 32 to resume temporarily terminated test control. When receiving a request for a resumption of temporarily terminated test control from the client 30, the recovered-data-transmitting unit 48 transmits a recovery message to the client 30. The recovery message is based on the control information, which is relevant to the request received from the client and is saved in the database 40, and based on the response data saved in the database 40 and associated with the control information. In this way, the client 30 is capable of receiving the response data obtained as a result of continued execution of the test control upon the tentative termination of the job.

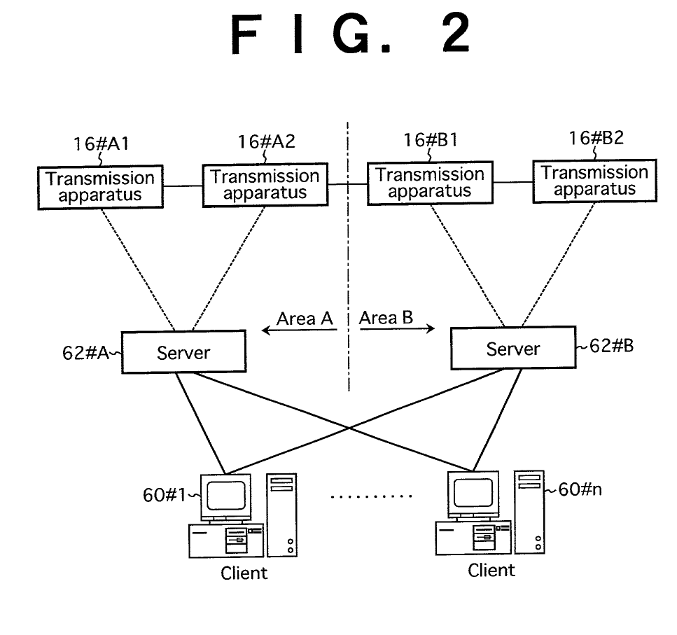

FIG. 2 is a block diagram showing the configuration of a client-server system implemented by an embodiment of the present invention. As shown in FIG. 2, the client-server system comprises a plurality of clients 60#i where i=1 to n, a plurality of servers 62#i where i=A, B and so on, a plurality of transmission apparatuses 16#ij where i=A, B and so on and j=1, 2 and so on and transmission lines connecting the servers 62#i, the clients 60#i and the transmission apparatuses 16#ij to each other. The clients 60#i where i=1 to n can each be any apparatus as long as the apparatus is capable of requesting the server 62#i to control the transmission apparatus 16#ij, which serves as a controlled-apparatus. In this particular embodiment, the transmission apparatus 16#ij is a controlled apparatus and the client 60#i is a personal computer that is capable of requesting the server 62#i to control the transmission apparatus 16#ij and provided with software having functions of test control as follows.

1: A function to control screens for a tentative termination and a resumption in addition to control of the conventional screens. A tentative termination is a termination of a client job or a tentative termination of a job related to test control. For example, a job related to current test control is terminated temporarily in order to execute test control on another controlled apparatus. In the event of a tentative termination, the server 62#i actually requests the controlled apparatus 16#ij to continue execution of the test control. An example of a job subjected to a tentative termination is a job periodically executing test control. In this embodiment, collection of measurement results is used as an example in the exemplification of a job subjected to a tentative termination. In a tentative termination, a memory used for test control is released to other test control so that the other test control can be executed.

A resumption is a termination of a halt state of transmissions and receptions of execution results related to test control executed in a transmission apparatus 16#ij between a client 60#i and a server 62#i upon a recovery of an abnormality occurring in the connection between the client 60#i and the server 62#i. The results of execution are automatically collected during a period between the start of the halt state and the time of the resumption and transmitted from the server 62#i to the client 60#i to be displayed on a screen of the client 60#i. A resumption can be initiated by a client other than the client which requested a tentative termination. For security purposes, however, a resumption can be initiated by a client other than the client requesting a tentative termination only if the same login ID as the login ID of the client requesting a tentative termination is entered to the other client. There is a variety of conceivable methods for displaying results of execution on a screen. There is possibly a plurality of resumed test control operations. Thus, from a standpoint of improving a human-machine interface with the operator, however, a list of such resumed test control operations is first displayed on the screen. Then, the operator is allowed to select a test control operation, execution results of which are to be displayed, among the test control operations on the displayed list. Finally, execution results of the selected test control operation are displayed on the screen.

2: A function to specify an item relevant to test control. In addition to operations to catalog data in the conventional network configuration database and commands given to a server, the operator is allowed to enter such an item to the server 62#i via the client 60#i as a request for a tentative termination, a request for a list cited above and a selection of a test control operation from such a list. A network configuration database is a database defining a topology of a network comprising transmission apparatuses 16#ij. The topology includes information on connection relations and transmission speeds.

3: A function to display a list and collected measurement results of a selected test control operation. In addition to the conventional function to display test results received from the server 62#i on the screen, the client 60#i receives a list from the server 62#i and collected measurement results of a test control operation selected from the list also from the server 62#i, displaying the list and the results on the screen.

4: A function to issue a command of automatically collecting measurement results of a test control operation selected from the list to the server 62#i. The collected measurement results are displayed automatically when a job is resumed.

The server 62#i has the following test control functions:

1: A function to save information on a job at the start of client test control. The saved information allows the test control to be continued in the event of a tentative termination and a connection abnormality.

2: A function to execute test control on a controlled transmission apparatus 16#ij and inform the client 60#i of results of the test control, which are received from the transmission apparatus 16#ij, in accordance with a test-control request received from the client 60#i.

3: A function of requesting a controlled transmission apparatus 16#ij to continue a test-control job, the tentative termination of which is requested by the client 60#i, in accordance with the saved information. The continued job is typically a job of collecting results of measurement periodically. Normally, the collection of measurement results is manual or automatic. In the case of manual collection, the client 60#i requests the server 62#i to collect results of measurement in accordance with a command entered by the operator to the client 60#i. In the case of automatic collection, on the other hand, the server 62#i automatically collects results of measurement at a period entered by the operator to the client 60#i. A continued test-control job, the tentative termination of which is requested by the client 60#i, can be automatic collection of measurement results, or automatic collection of measurement results as well as manual collection of measurement results. As described above, in the case of the automatic collection, the server 62#i automatically collects results of measurement at a measurement period specified by the operator. In the case of the manual collection, on the other hand, the measurement period is a period determined by the system in advance, or a period based on a history of commands entered so far to make a request for a manual collection. of measurement results. It should be noted that, in this embodiment, a continued test-control job, the tentative termination of which is requested by the client 60#i, is the automatic collection of measurement results.

4: A function to monitor the state of the connection between a 60#i and the server 62#i and request a controlled transmission apparatus 16#ij to continue a test-control job in the same way as a requested tentative termination in case an abnormality is detected in the connection between the client 60#i and the server 62#i. An abnormality in the connection between the client 60#i and the server 62#i is a state of no response received from the client 60#i. Evidenced by the fact that a display on the screen of the client 60#i is frozen, such an abnormality is typically caused by a turned-off power supply of the client 60#i or a failure occurring on a transmission line between the client 60#i and the server 62#i.

5: A function to save results received from a controlled transmission apparatus 16#ij during a continued test-control job.

6: A function to transmit a list of continued test-control jobs to a client 60#i at a request made by the client 60#i. The test-control jobs have been continued by a request for a tentative termination or in the event of a connection abnormality. As described above, a test-control job is continued in the event of tentative termination requested by a client. From a security-protection point of view, however, a test-control job can only be selected from the list by a client specifying the same login ID as the client requesting the tentative termination. Also as described above, measurement results of a selected test-control job are displayed on the screen of the client.

7: A function to transmit measurement results of a continued test-control job selected by a client 60#i to the client 60#i when receiving a request for such measurement results from the client 60#i.

In addition to functions of an ordinary transmission apparatus, as a controlled apparatus, the transmission apparatus 16#ij also has the following functions:

1: A function to carry out a test according to test control requested by a server 62#i. For examples, jobs related to the test control include connection of a test circuit at the beginning of the test, insertion of a test signal, commence of a measurement, collection of measurement results, removal of the test circuit and discontinuation of the test-signal insertion.

2: A function to transmit results of job-execution to the server 62#i as response data.

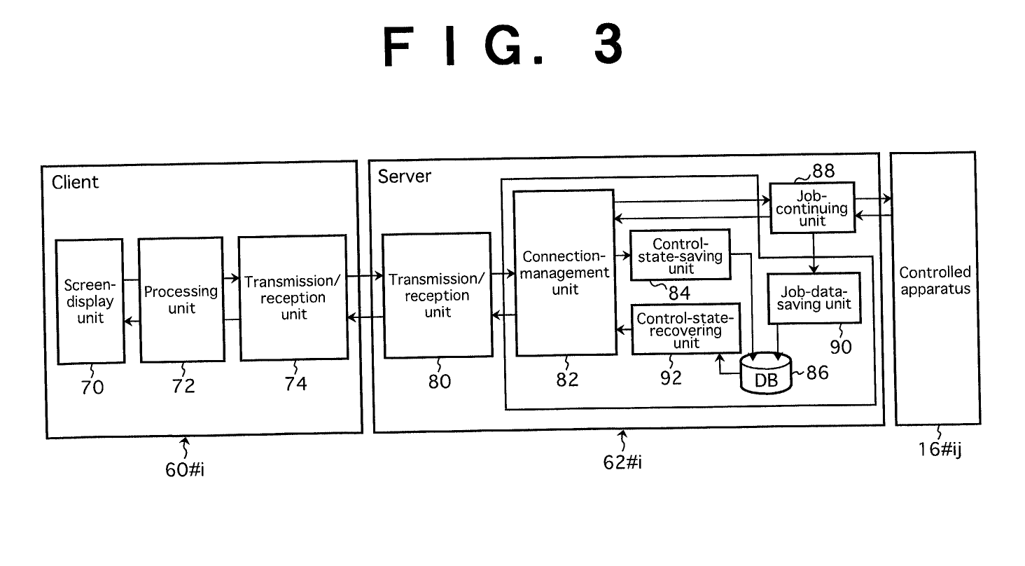

FIG. 3 is a block diagram showing the configuration of the client 60#i and the server 62#i, which are employed in the client-server system shown in FIG. 2. As shown in FIG. 3, the client 60#i comprises a screen-display unit 70, a processing unit 72 and a transmission/reception unit 74. The screen-display unit 70 has the following functions related to screen control of test control:

1: A function to execute control by securing a memory for screen control and opening a network configuration management initial screen when the operator enters a login ID and selects network configuration management. The network configuration management initial screen is an initial screen for executing communication monitoring control. Typically, the network configuration management initial screen shows items including network management, configuration control, information search, utilities, resumption, network connection management, completion, download completion and upload completion. The resumption is an operation to resume test control. The network management is management of transmission apparatuses 16#ij composing the network. The configuration control is operation control and test control.

2: A function to control screens subordinate to the initial screen. For example, a test-control subordinate screen displays a test start, a test method, a measurement start, a measurement end, a test end, collection of measurement results and tentative termination. A resumption subordinate screen displays a list of information on test-control operations each continued by a tentative termination or a connection abnormality. The screen then displays measurement results for a test-control operation selected from the list.

3: A function to request the processing unit 72 to carry out operations according to an item selected among those displayed on a screen.

4: A function to display a screen based on data generated by the processing unit 72.

The processing unit 72 creates a processing request message according to a request received from the screen-display unit 70 and outputs the message to the transmission/reception unit 74. The processing unit 72 passes on response data received from the transmission/reception unit 74 to the screen-display unit 70. The transmission/reception unit 74 transmits the processing request message received from the processing unit 72 to the server 62#i. The transmission/reception unit 74 receives the response data from the server 62#i and passes on the data to the processing unit 72.

The server 62#i comprises a transmission/reception unit 80, a connection-management unit 82, a control-state-saving unit 84, a database (DB) 86, a job-continuing unit 88, a job-data-saving unit 90 and a control-state-recovering unit 92. The transmission/reception unit 80 has the following functions:

1: A function to receive a processing request message from the client 60#i and passes on the message to the connection-management unit 82.

2: A function to pass on data received from the connection-management unit 82 to the client 60#i.

The connection-management unit 82 has the following functions:

1: A function to carry out the following pieces of processing according to a processing request message received from the transmission/reception unit 80.

1-i: Acquire a control state for continuing a job of collecting results of measurement from the control-state-saving unit 84 if the processing request message indicates a tentative termination, create a measurement-result collection message, output the measurement-result collection message to the job-continuing unit 88, put the status of the measurement-result collection message in tentative-termination status and request the control-state-saving unit 84 to store the status in the database 86.

1-ii: When requested by a client 60#i through a list-requesting message, acquire a list of test-control operations from the control-state-recovering unit 92 and output the list to the transmission/reception unit 80. The test-control operations on the list are relevant to a client 60#i storing a login ID matching a login ID included in the list-requesting message. The client 60#i may be in status of requesting a tentative termination or abnormal-connection status.

1-iii: When receiving information on a test-control operation selected from the list, acquire measurement results for the selected test-control operation from the control-state-recovering unit 92 and output the results to the transmission/reception unit 80.

1-iv: Output a processing request message other than a message for processing 1-i, 1-ii and 1-iii to the job-continuing-unit 88 and the control-state-saving unit 84.

2: A function to-monitor the state of the connection between the client 60#i and the server 62#i through the transmission/reception unit 80. The state of the connection is monitored by periodically transmitting a monitoring signal to the client 60#i and determines that the connection is abnormal if a response to the signal is not received within a predetermined period of time.

3: A function to acquire a control state concerning collection of measurement results related to the client 60#i from the control-state-saving unit 84 and create a measurement-result collection message in the event of a connection abnormality. The measurement-result collection message is output to the job-continuing unit 88.

4: A function to periodically create a measurement-result collection message for a tentative termination or a connection abnormality and output the message to the job-continuing unit 88. This function is ended typically when results of measurement for a test-control operation selected from the list are transmitted to the client 60#i.

5: A function to output result data received from a controlled transmission apparatus 16#ij through the job-continuing unit 88 to the transmission/reception unit 80 if the data is not results of measurement collected in the event of a tentative termination or a connection abnormality.

6: A function to request the control-state-saving unit 84 to delete a control state related to a test when the test is ended. The control state is described below.

The control-state-saving unit 84 has the following functions:

1: A function to save a control state in the database 86 when a processing request message is received from the connection-management unit 82. A control state is information required for continuing an operation to collect results of measurement. A measurement-result collection message is received from the client 60#i at a predetermined period. By storing only the control state related to the first measurement-result collection message, however, the database 86 can be made compact. Thus, the database 86 can be searched for desired data at a high speed.

2: A function to store a state related to collection of measurement results in the database 86 in accordance with a command issued by the connection-management unit 82.

3: A function to delete control information, response data and a state, which are related to test control requested for deletion, from the database 86 at a request made by the connection-management unit 82.

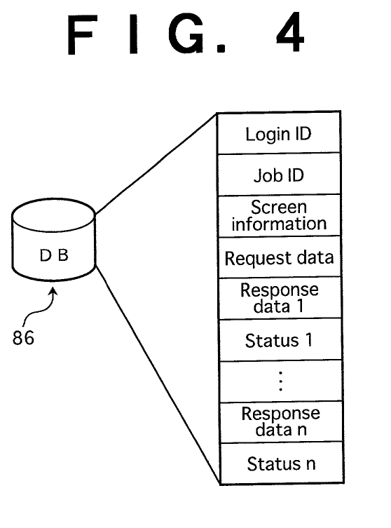

FIG. 4 is a diagram showing the configuration of the database 86 employed in the server 62#i employed in the client-server system shown in FIG. 3. As shown in FIG. 4, the database 86 includes a login ID, a job ID, screen information, request data, response data i where i=1 to n and status i where i=1 to n. The login ID is an ID, which is specified by the operator when the operator opens a network management configuration screen. The login ID is included in a processing request message received from the client 60#i. The job ID is an ID used for identifying a job. The job ID can be regarded as the job's category used for determining whether or not the job is an object to be continued. The screen information is information entered to a screen. In the case of test control, for example, the screen information includes a test start, a measurement start and collected results of measurement. As described above, a method of measurement can be manual or automatic. In the case of the automatic method of measurement, a period of a measurement is included in the screen information including the start of the measurement. The request data is information other than the information entered to a screen. An example of the request data is information used for identifying a transmission apparatus 16#ij to be tested.

The response data is data received from a transmission apparatus 16#ij serving as a tested object, which transmits the data in response to a command given to the transmission apparatus 16#ij. The response data includes data transmitted by the transmission apparatus 16#ij in response to a request for collection of measurement results in the event of a tentative termination or a detected connection abnormality. Status is information used for indicating whether the response data is transmitted in response to a request for a tentative termination, the response data is transmitted in the event of a detected connection abnormality or the response data is transmitted in response to an ordinary request made by a client 60#i. In the case of response data transmitted in response to a request for a tentative termination or in the event of a detected connection abnormality, results of measurement are collected at a predetermined period till the client 60#i selects a test-control operation from those on the list described earlier. Thus, following the response data received from the transmission apparatus 16#ij in response to a request for collection of measurement results, which is made by the client 60#i by issuing a command specifying a manual or automatic method of result collection, pieces of response data received at a predetermined period are sequentially stored a piece after another along with connection status used for indicating whether the piece of response data is transmitted in response to a request for a tentative termination or the piece of response data is transmitted in the event of a detected connection abnormality.

The job-continuing unit 88 has the following functions:

1: A function to convert a processing request message received from the connection-management unit 82 into data having a format for a controlled transmission apparatus 16#ij and output the data to the transmission apparatus 16#ij as a request for processing.

2: A function to receive response data from the transmission apparatus 16#ij, which transmits the response data in response to the request for processing, convert the format of the response data and output the response data to the connection-management unit 82 as well as the job-data-saving unit 90. The job-data-saving unit 90 stores the response data received from the job-continuing unit 88 in the database 86 as response data associated with the request for processing.

The control-state-recovering unit 92 has the following functions:

1: A function to read out control status from the database 86 at a request received from the connection-management unit 82 as a list-requesting message and output the control status to the connection-management unit 82. The control status is read out from an area with a stored login ID matching the login ID included in the list-requesting message. The control status is relevant to results of measurement, which are collected in the event of a tentative termination or a detected connection abnormality.

2: A function to read out response data stored as collected results of measurement, which are selected by the client 60#i as indicated by a request made by the connection-management unit 82, from the database 86 and output the response data to the connection-management unit 82.

Next, the operation of the client-server system shown in FIG. 2 is explained.

<1> Processing a Request from the Client 60#i for the Server 62#i

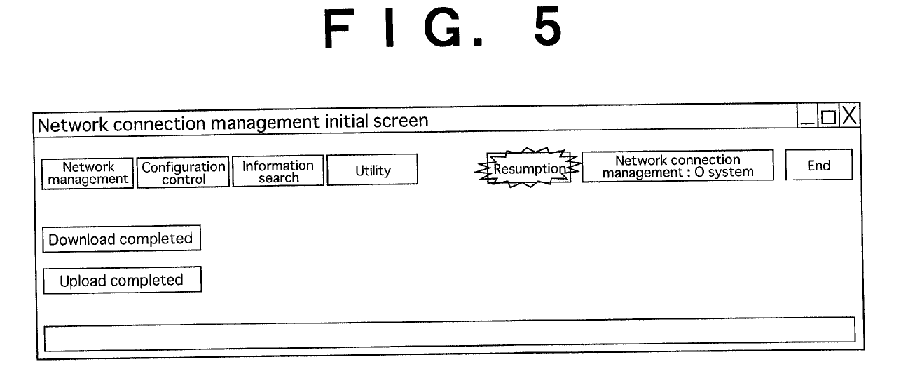

In order to open a network-connection management initial screen, the operator needs to enter a login ID and select a network management button. The screen-display unit 70 then displays a typical network-connection management initial screen like one shown in FIG. 5 after saving the login ID.

FIG. 5 is a diagram showing a typical network connection management initial screen. As shown in the figure, the typical network connection management initial screen displays, among other information, network-management, configuration-control, information-search and utility menu buttons.

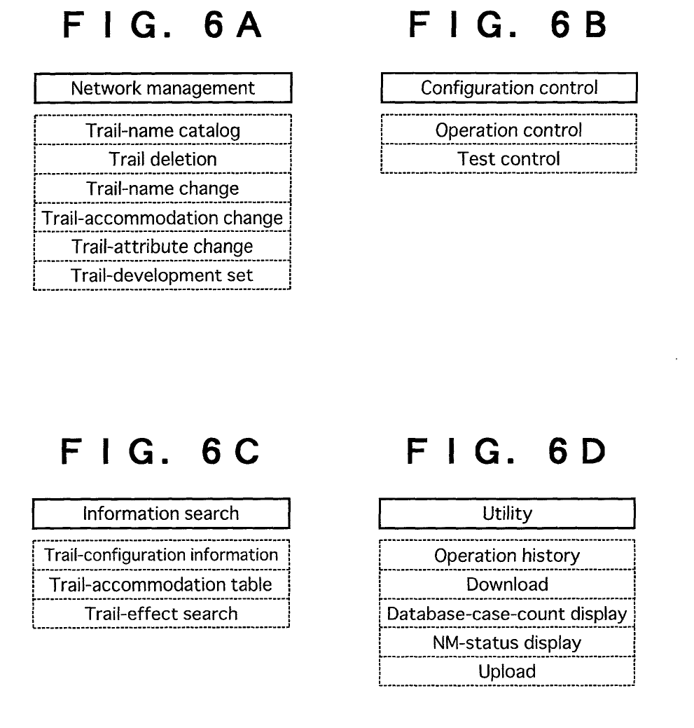

FIG. 6A is a diagram showing the configuration of a low-level menu of the network-management menu button displayed on the typical network connection management initial screen shown in FIG. 5. FIG. 6B is a diagram showing the configuration of a low-level menu of the configuration-control menu button displayed on the typical network connection management initial screen shown in FIG. 5. FIG. 6C is a diagram showing the configuration of a low-level menu of the information-search menu button displayed on the typical network connection management initial screen shown in FIG. 5. FIG. 6D is a diagram showing the configuration of a low-level menu of a utility menu button displayed on the typical network connection management initial screen shown in FIG. 5.

As-shown in FIG. 6A, the network management low-level menu is a menu for managing a network topology. The network management low-level menu displays trail-name catalog, trail deletion, trail-name change, trail-accommodation change, trail-attribute change and trail-development set items.

As shown in FIG. 6B, the configuration control low-level menu displays operation control and test control items. An operation control sub-menu is a menu for controlling an operation to switch a redundancy system of a transmission apparatus. On the other hand, a test-control sub-menu is a menu for carrying out, among other jobs, a transmissibility test.

As shown in FIG. 6C, the information-search low-level menu is a menu for searching for data and displaying the data found in the search. The information-search low-level menu displays trail-configuration information, trail-accommodation table and trail-effect search items.

As shown in FIG. 6D, the utility low-level menu is a menu displaying operation history, download, database-case-count display, NM-status display and upload items. The upload item is selected to acquire data from a low-level apparatus. On the other hand, the download item is selected to supply data to a low-level apparatus. With such items, data cataloged in a certain client can be downloaded to another client to be used in the other client.

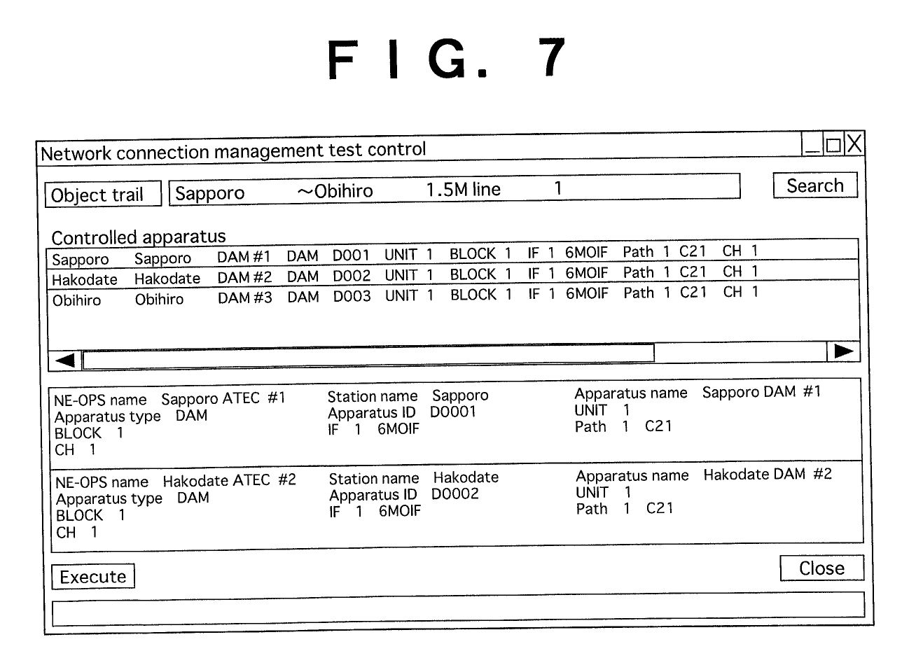

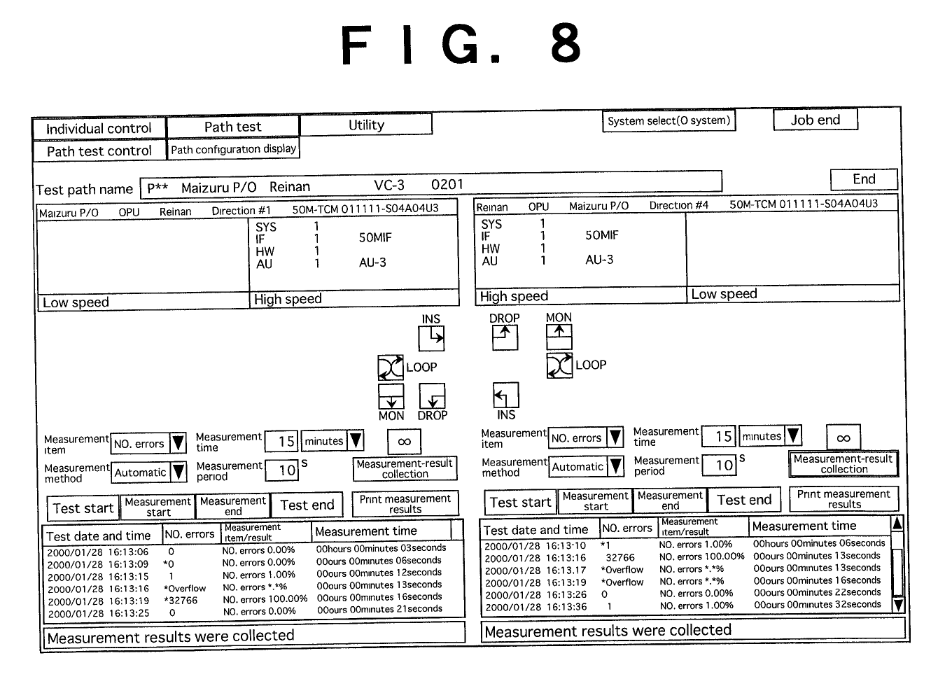

FIG. 7 is a diagram showing a typical test control screen. As shown in FIG. 7, the test-control screen selected by specifying the test-control item displays a controlled-tray item, a list of controlled transmission apparatuses, a transmission-apparatus-information table including pieces of information on selected transmission apparatuses, an execute button, a close button and a list of execution results. By selecting the execute button, the following path test control screen is displayed. FIG. 8 is a diagram showing a typical path test control screen. As shown in FIG. 8, the path test control screen displayed by selection of the execute button displays pieces of information including a tested-path name, information on transmission apparatuses involved in the tested path, a test-item window, a collected-measurement-result window, a system-select item and a job-end item. The test-item window displays a test method, a measured item, a measurement method, a measurement period and collected results of measurement. The test method is information showing a method for conducting-the-test. The information on a test method is INS (insertion), LOOP, MON (monitor) and DROP. The measured item includes the number of errors. The measurement method can be manual or automatic. The collected-measurement-result window displays collected results of measurement. The system-select item is an item used for selecting a system of a transmission apparatus to be tested. The job-end item is an item used for terminating the test-control screen.

<2> Normal Connection

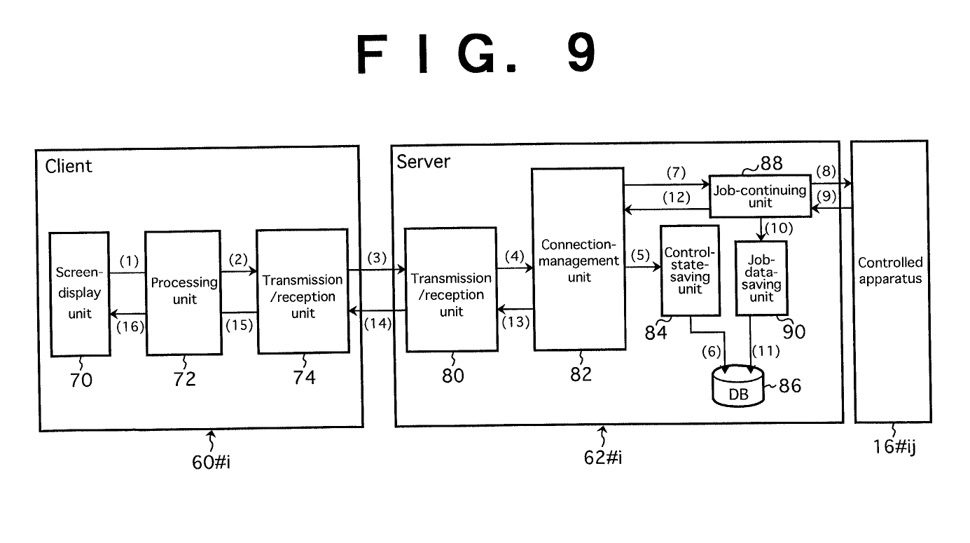

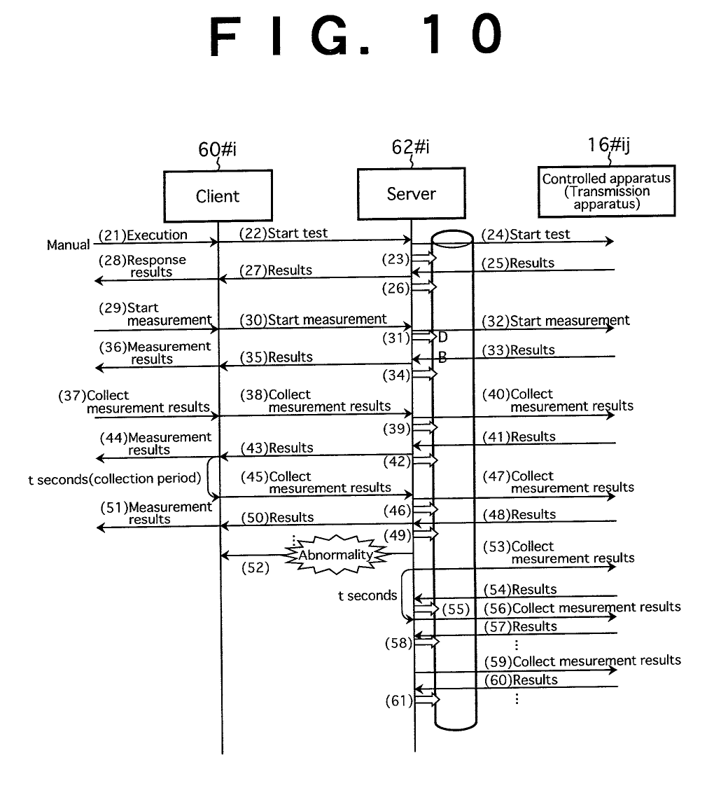

FIG. 9 is a diagram showing flows of processing for a normal-connection case and FIG. 10 is a sequence chart of a test for an abnormal-connection case. When the operator enters a login ID, the screen-display unit 70 employed in the client 60#i displays a communication-control initial screen. When the operator specifies information such as test control and a test-controlled path as indicated by an arrow (21) shown in FIG. 10, the screen-display unit 70 supplies information including a login ID, the test control and the test-controlled path to the processing unit 72 as indicated by an arrow (1) shown in FIG. 9. The processing unit 72 creates a test-start message including the login ID, the test control and the test-controlled path, outputting the message to the transmission/reception unit 74 as indicated by an arrow (2) shown in FIG. 9. The transmission/reception unit 74 transmits the test-start message to the server 62#i as indicated by an arrow (3) shown in FIG. 9 and an arrow (22) shown in FIG. 10. The transmission/reception unit 80 employed in the server 62#i passes on the test-start message to the connection-management unit 82 as indicated by an arrow (4) shown in FIG. 9. The connection-management unit 82 supplies the test-start message and information indicating a normal state to the control-state-saving unit 84 as indicated by an arrow (5) shown in FIG. 9. The control-state-saving unit 84 stores the information indicating a normal state, request data, screen information, a job ID identifying the test control and a login ID included in the test-start message in the database 86 as indicated by an arrow (6) shown in FIG. 9 and an arrow (23) shown in FIG. 10.

The connection-management unit 82 outputs the test-start message also to the job-continuing unit 88 as indicated by an arrow (7) shown in FIG. 9. The job-continuing unit 88 passes on the test-start message to a controlled transmission apparatus 16#ij as indicated by an arrow (8) shown in FIG. 9 and an arrow (24) shown in FIG. 10. When receiving the test-start message, the transmission apparatus 16#ij connects a test circuit and inserts a test signal. The transmission apparatus 16#ij then transmits results of the test to the server 62#i as indicated by an arrow (9) shown in FIG. 9 and an arrow (25) shown in FIG. 10. The job-continuing unit 88 employed in the server 62#i passes on the test results received from the transmission apparatus 16#ij to the job-data-saving unit 90 as indicated by an arrow (10) shown in FIG. 9. The job-data-saving unit 90 stores the results of the test in the database 86 as response data as indicated by an arrow (11) shown in FIG. 9 and an arrow (26) shown in FIG. 10. The job-continuing unit 88 also outputs the results of the test to the connection-management unit 82 as indicated by an arrow (12) shown in FIG. 9. The connection-management unit 82 passes on the results of the test to the transmission/reception unit 80 as indicated by an arrow (13) shown in FIG. 9. The transmission/reception unit 80 transmits the results of the test to the client 60#i as indicated by an arrow (14) shown in FIG. 9 and an arrow (27) shown in FIG. 10. The transmission/reception unit 74 employed in the client 60#i supplies the results of the test to the screen-display unit 70 by way of the processing unit 72 as indicated by arrows (15) and (16) shown in FIG. 9. The screen-display unit 70 displays the results of the test on a screen as indicated by an arrow (28) shown in FIG. 10.

By the same token, when the operator selects a measurement-start button after setting information such as a measurement item, a measurement method, a measurement time and a measurement period as indicated by an arrow (29) shown in FIG. 10, the client 60#i transmits a measurement-start message including a login ID, test-control information, the measurement item, the measurement method and the measurement time to the server 62#i as indicated by an arrow (30) shown in FIG. 10. The server 62#i stores the received measurement-start message in the database 86 as indicated by an arrow (31) shown in FIG. 10. The server 62#i transmits the measurement-start message to a controlled transmission apparatus 16#ij as indicated by an arrow (32) shown in FIG. 10. Receiving the measurement-start message, the transmission apparatus 16#ij starts a measurement. The transmission apparatus 16#ij then transmits results of the measurement start to the server 62#i as indicated by an arrow (33) shown in FIG. 10. The server 62#i stores the results of the measurement start in the database 86 as response data as indicated by an arrow (34) shown in FIG. 10. The server 62#i then transmits the results of the measurement start to the client 60#i as indicated by an arrow (35) shown in FIG. 10. The client 60#i displays the results of the measurement start on a screen as indicated by an arrow (36) shown in FIG. 10.

In the same way, when the operator selects a measurement-result-collection button as indicated by an arrow (37) shown in FIG. 10, the client 60#i transmits a measurement-result-collection message, a login ID and test-control information to the server 62#i as indicated by an arrow (38) shown in FIG. 10. When receiving the measurement-result-collection message, the server 62#i stores the login ID, a job ID, screen information and request data, which are relevant to collection of measurement results, in the database 86 as indicated by an arrow (39) shown in FIG. 10, provided that the measurement-result-collection message is a first request for collection of measurement results. The measurement-result-collection message is determined to be a first request for collection of measurement results as follows. The database 86 is searched for a login ID, a job ID, screen information and request data that match respectively the login ID, the job ID, the screen information and the request data, which serve as a key relevant to collection of measurement results. If such a login ID, a job-ID, screen information and request data are not found in the search operation, the measurement-result-collection message is determined to be a first request for collection of measurement results. The server 62#i transmits the measurement-result-collection message to a controlled transmission apparatus 16#ij as indicated by an arrow (40) shown in FIG. 10. Receiving the measurement-result-collection message, the transmission apparatus 16#ij collects results of measurement. The transmission apparatus 16#ij then transmits collected results of measurement to the server 62#i as indicated by an arrow (41) shown in FIG. 10. The server 62#i stores the collected results of measurement in the database 86 as response data as indicated by an arrow (42) shown in FIG. 10. The server 62#i then transmits the collected results of measurement to the client 60#i as indicated by an arrow (43) shown in FIG. 10. The client 60#i displays the collected results of measurement on a screen as indicated by an arrow (44) shown in FIG. 10.

If the automatic measurement method is specified, the client 60#i transmits a measurement-result-collection message to the server 62#i at collection intervals of t seconds as indicated by an arrow (45) shown in FIG. 10. The server 62#i stores the received measurement-result-collection message-in the database 86 as indicated by an arrow (46) shown in FIG. 10. The server 62#i then transmits the measurement-result-collection message to a controlled transmission apparatus 16#ij as indicated by an arrow (47) shown in FIG. 10. Receiving the measurement-result-collection message, the transmission apparatus 16#ij collects results of measurement. The transmission apparatus 16#ij then transmits the collected results of measurement to the server 62#i as indicated by an arrow (48) shown in FIG. 10. The server 62#i stores the collected results of measurement in the database 86 as response data as indicated by an arrow (49) shown in FIG. 10. The server 62#i then transmits the collected results of measurement to the client 60#i as indicated by an arrow (50) shown in FIG. 10. The client 60#i displays the collected results of measurement on a screen as indicated by an arrow (51) shown in FIG. 10.

<3> Connection Abnormality

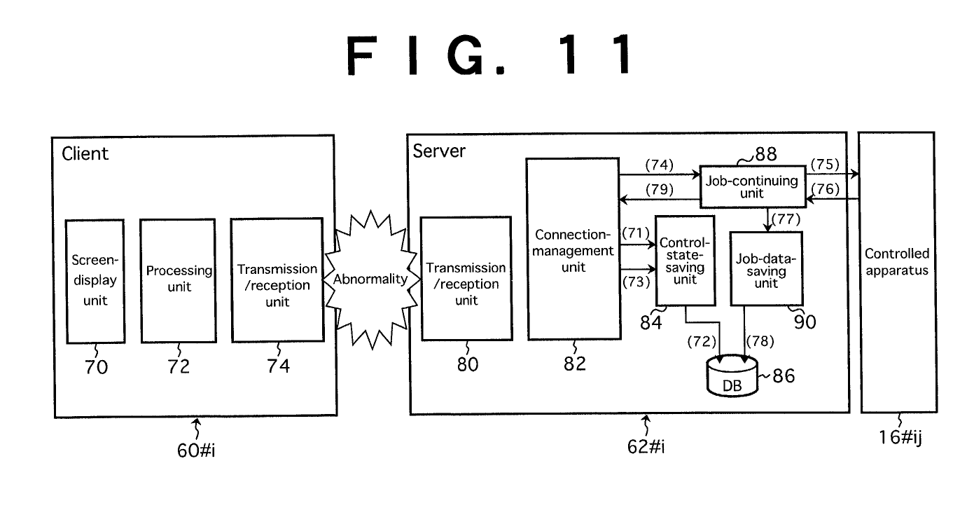

FIG. 11 is a diagram showing flows of processing for an abnormal-connection case. Assume that a connection abnormality occurs as indicated by an arrow (52) shown in FIG. 10. A connection abnormality is a state in which communications between the client 60#i and the server 62#i become impossible due to a transmission line failure as evidenced typically by a frozen screen of the client 60#i. The connection-management unit 82 is monitoring the state of communication between the client 60#i and the server 62#i and detects a discontinued communication as a connection abnormality. In the event of a connection abnormality, the connection-management unit 82 requests the control-state-saving unit 84 to read out information relevant to collection of measurement results as indicated by an arrow (71) shown in FIG. 11. The control-state-saving unit 84 searches the database 86 for request data and screen information relevant to measurement-result collection with an automatic measurement method as indicated by an arrow (72) shown in FIG. 11. The control-state-saving unit 84 then supplies the request data and the screen information to the connection-management unit 82 as indicated by an arrow (73) shown in FIG. 11. As a measurement period t specified in the measurement method lapses since a connection-abnormality detection time or since an automatic-measurement-result-collection time specified by the client 60#i, the connection-management unit 82 creates a measurement-result-collection message and outputs the message to the job-continuing unit 88 as indicated by an arrow (74) shown in FIG. 11. The connection-management unit 82 then stores a state related to the collection of measurement results in the database 86 through the control-state-saving unit 84 as an abnormal state. The job-continuing unit 88 transmits the measurement-result-collection message to a transmission apparatus 16#ij as indicated by an arrow (56) shown in FIG. 10 and an arrow (75) shown in FIG. 11.

Receiving the measurement-result-collection message, the transmission apparatus 16#ij collects results of measurement. The transmission apparatus 16#ij then transmits the collected results of measurement to the server 62#i as indicated by an arrow (57) shown in FIG. 10 and an arrow (76) shown in FIG. 11. The job-continuing unit 88 employed in the server 62#i passes on the collected results of measurement to the job-data-saving unit 90 as indicated by an arrow (77) shown in FIG. 11. The job-data-saving unit 90 stores the collected results of measurement in the database 86 as indicated by an arrow (58) shown in FIG. 10 and an arrow (78) shown in FIG. 11 as response data corresponding to a state related to the collection of measurement results. The job-continuing unit 88 also outputs the collected results of measurement to the connection-management unit 82 as indicated by an arrow (79) shown in FIG. 11. Due to the connection abnormality, however, the connection-management unit 82 does not supply the collected results of measurement to the transmission/reception unit 80. In the same way, for each period t of collection of measurement results, results of measurement are continuously collected and stored in the database 86 as indicated by arrows (59) to (61) shown in FIG. 10.

<4> Tentative Termination

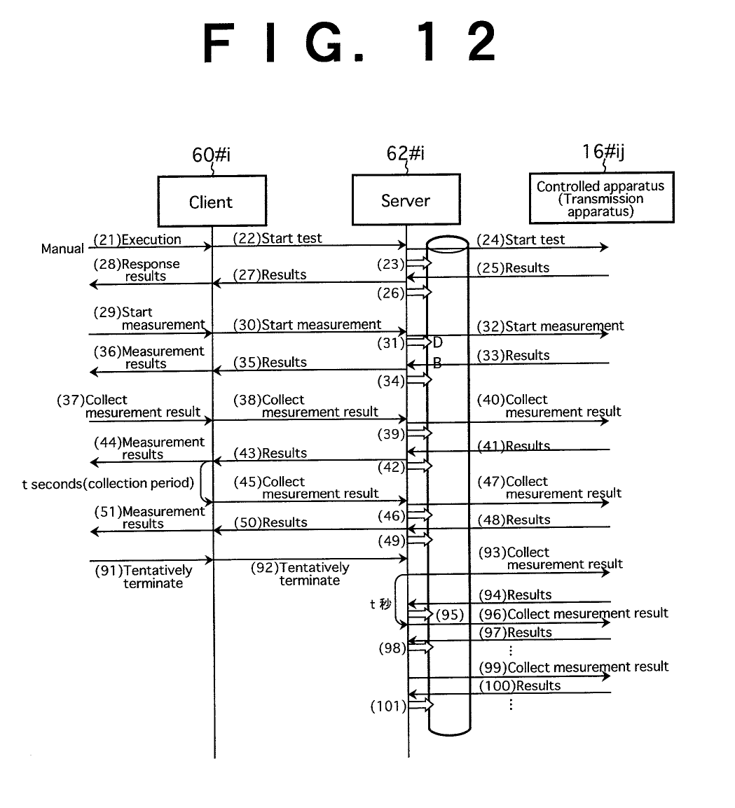

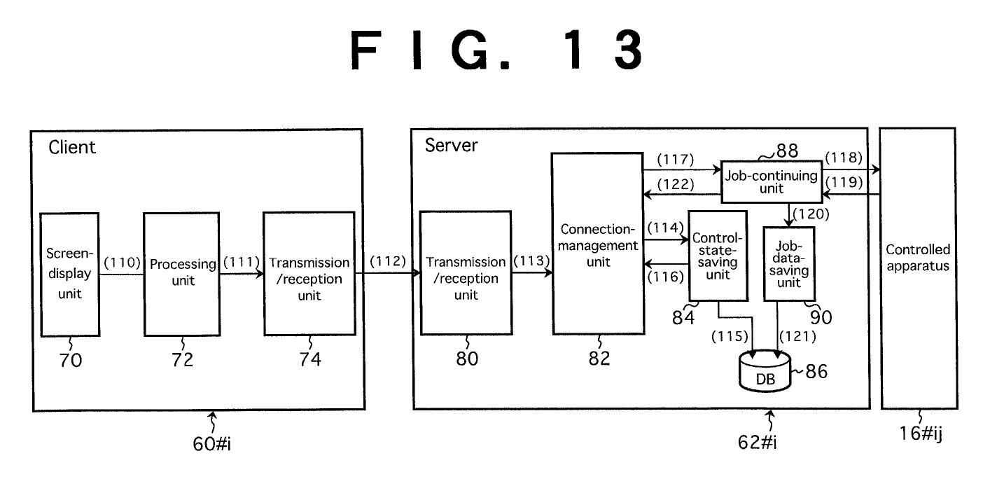

FIG. 12 is a sequence chart for a tentative termination case. Pieces of processing that are virtually identical with those shown in FIG. 10 are denoted by the same reference numerals as those shown in FIG. 10. FIG. 13 is a diagram showing flows of processing for a tentative termination case. Since the pieces of processing that are denoted by arrows (21) to (51) in FIG. 12 are identical with their counterparts shown in FIG. 10, their explanation is not repeated. When terminating a job at the end of the job or prior to the start of another job, the operator selects a tentative-termination button displayed on the screen shown in FIG. 5 as indicated by an arrow (91) shown in FIG. 12. When the tentative-termination button is selected, the screen-display unit 70 requests the processing unit 72 to carry out a tentative termination as indicated by an arrow (110) shown in FIG. 13. The processing unit 72 creates a tentative-termination message and outputs the message to the transmission/reception unit 74 as indicated by an arrow (111) shown in FIG. 13. In addition, when the tentative-termination button is selected, the screen-display unit 70 releases the memory area for the job and returns the control to the initial screen. With the initial screen displayed, the operator is capable of again opening the network-connection-management initial screen to start another job. The transmission/reception unit 74 transmits the tentative-termination message to the server 62#i as indicated by an arrow (92) shown in FIG. 12 and an arrow (112) shown in FIG. 13. The transmission/reception unit 80 employed in the server 62#i passes on the tentative-termination message to the connection-management unit 82 as indicated by an arrow (113) shown in FIG. 13. The connection-management unit 82 requests the control-state-saving unit 84 to read out information related to collection of measurement results from the database 86 as indicated by an arrow (114) shown in FIG. 13. The control-state-saving unit 84 searches the database 86 for request data and screen information. relevant to measurement-result collection with an automatic measurement method as indicated by an arrow (115) shown in FIG. 13. The control-state-saving unit 84 then supplies the request data and the screen information to the connection-management unit 82 as indicated by an arrow (116) shown in FIG. 13.

As a measurement period t specified in the measurement method lapses since a connection-abnormality detection time, the connection-management unit 82 creates a measurement-result-collection message and outputs the message to the job-continuing unit 88 as indicated by an arrow (117) shown in FIG. 13. The connection-management unit 82 stores a state related to the collection of measurement results in the database 86 through the control-state-saving unit 84 as a tentative-termination state. The job-continuing unit 88 transmits the measurement-result-collection message to a transmission apparatus 16#ij as indicated by an arrow (93) shown in FIG. 12 and an arrow (118) shown in FIG. 13.

Receiving the measurement-result-collection message, the transmission apparatus 16#ij collects results of measurement. The transmission apparatus 16#ij then transmits the collected results of measurement to the server 62#i as indicated by an arrow (94) shown in FIG. 12 and an arrow (119) shown in FIG. 13. The job-continuing unit 88 employed in the server 62#i passes on the collected result of measurement to the job-data-saving unit 90 as indicated by an arrow (120) shown in FIG. 13. The job-data-saving unit 90 stores the collected results of measurement in the database 86 as indicated by an arrow (95) shown in FIG. 12 and an arrow (121) shown in FIG. 13 as response data corresponding to a state related to the collection of measurement results. The job-continuing unit 88 also outputs the collected results of measurement to the connection-management unit 82 as indicated by an arrow (122) shown in FIG. 13. Due to the tentative termination notice, however, the connection-management unit 82 does not supply the collected results of measurement to the transmission/reception unit 80. In the same way, for each period t of collection of measurement results, results of measurement are continuously collected and stored in the database 86 as indicated by arrows (96) to (101) shown in FIG. 12.

<5> Resumption

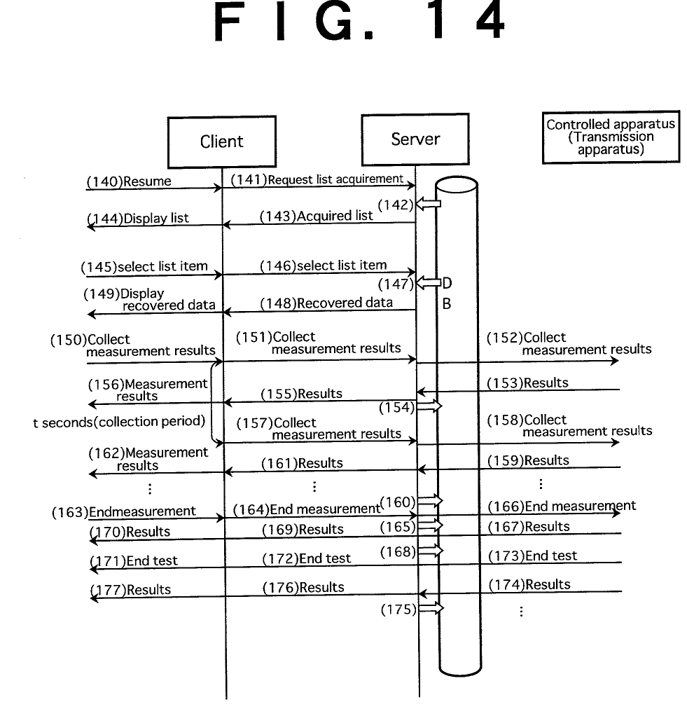

FIG. 14 is a sequence chart for a resumption.

<5-a> Request for a List

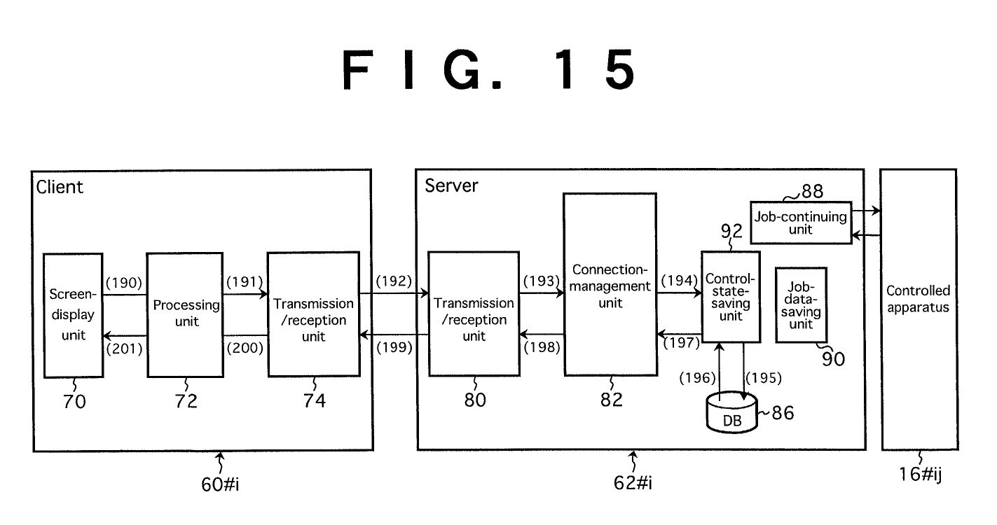

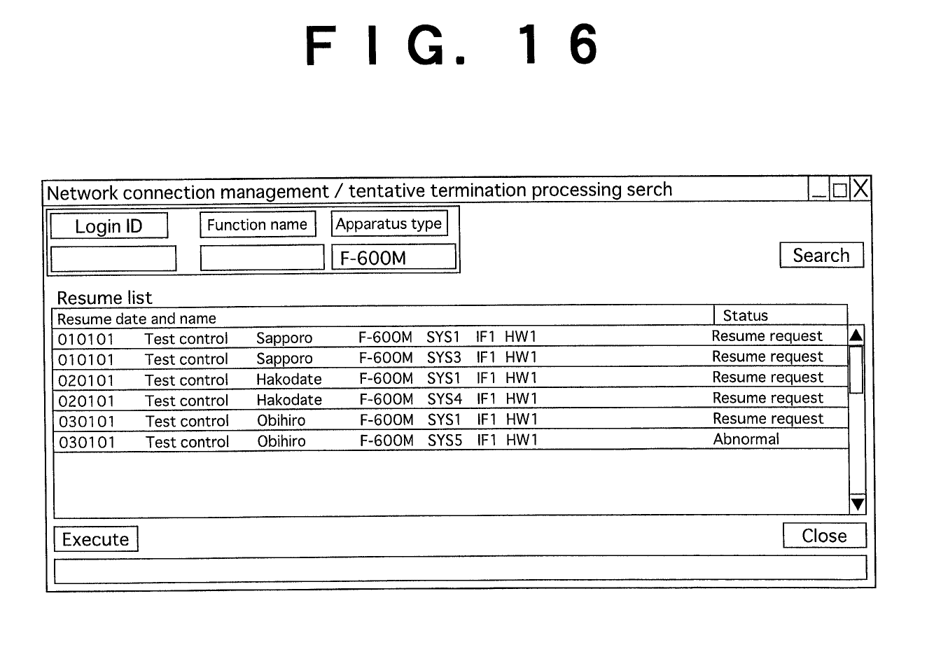

FIG. 15 is a diagram showing flows of processing of a request for a list and FIG. 16 is a diagram showing a typical tentative termination processing screen. When the connection is recovered or a tentative-termination state is ended, the operator enters a login ID and selects a resumption button on the screen of FIG. 5 as indicated by an arrow (140) shown in FIG. 14. When the resumption button is selected, the screen-display unit 70 displays a tentative-termination processing screen shown in FIG. 16. When the operator selects a search button displayed on the tentative-termination processing screen shown in FIG. 16, the screen-display unit 70 requests the processing unit 72 to make a request for acquirement of a list as indicated by an arrow (190) shown in FIG. 15. The processing unit 72 creates a list-acquirement request message including the login ID and outputs the message to the transmission/reception unit 74 as indicated by an arrow (191) shown in FIG. 15. The transmission/reception unit 74 transmits the list-acquirement request message to the server 62#i as indicated by an arrow (141) shown in FIG. 14 and an arrow (192) shown in FIG. 15. The transmission/reception unit 80 employed in the server 62#i passes on the list-acquirement request message to the connection-management unit 82 as indicated by an arrow (193) shown in FIG. 15. The connection-manaqement unit 82 requests the control-state-recovering unit 92 to read out a list specified by the list-acquirement request message from the database 86 as indicated by an arrow (194) shown in FIG. 15. The control-state-recovering unit 92 then makes an access to the database 86 as indicated by an arrow (195) shown in FIG. 15. Subsequently, the control-state-recovering unit 92 reads out all screen information and all request data from the database 86 as indicated by an arrow (196) shown in FIG. 15. The screen information and the request data have measurement-result request status set to connection-abnormality status or tentative-termination status. The request for results of measurement includes the same login ID as the login ID of the list-acquirement request message.

Since a login ID is used as a key in this way, screen information and request data are not read out unless they have a login ID matching the key login ID. Thus, security of the screen information and request data can be protected. The control-state-recovering unit 92 acquires a list of screen information, request data and status, which are read out from the database 86, and outputs the acquired list to the connection-management unit 82. The connection-management unit 82 passes on the acquired list to the transmission/reception unit 80 as indicated by an arrow (198) shown in FIG. 15. The transmission/reception unit 80 transmits the acquired list to the client 60#i as indicated by an arrow (143) shown in FIG. 14 and an arrow (199) shown in FIG. 15. The transmission/reception unit 74 employed in the client 60#i passes on the acquired list to the processing unit 72 as indicated by an arrow (200) shown in FIG. 15. The processing unit 72 employed in the client 60#i passes on the acquired list to the screen-display unit 70 as indicated by an arrow (201) shown in FIG. 15. The screen-display unit 70 extracts various kinds of status and information identifying tested transmission apparatuses from the acquired list and displays the status and the information on a resumption list screen shown in FIG. 16 as indicated by an arrow (144) shown in FIG. 14.

<5-b> Selecting an Item from the List

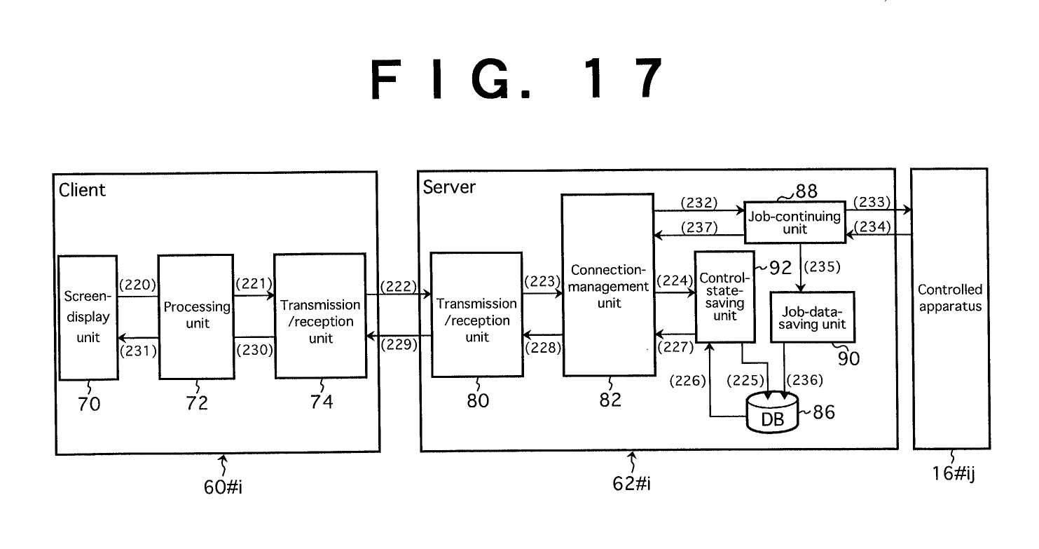

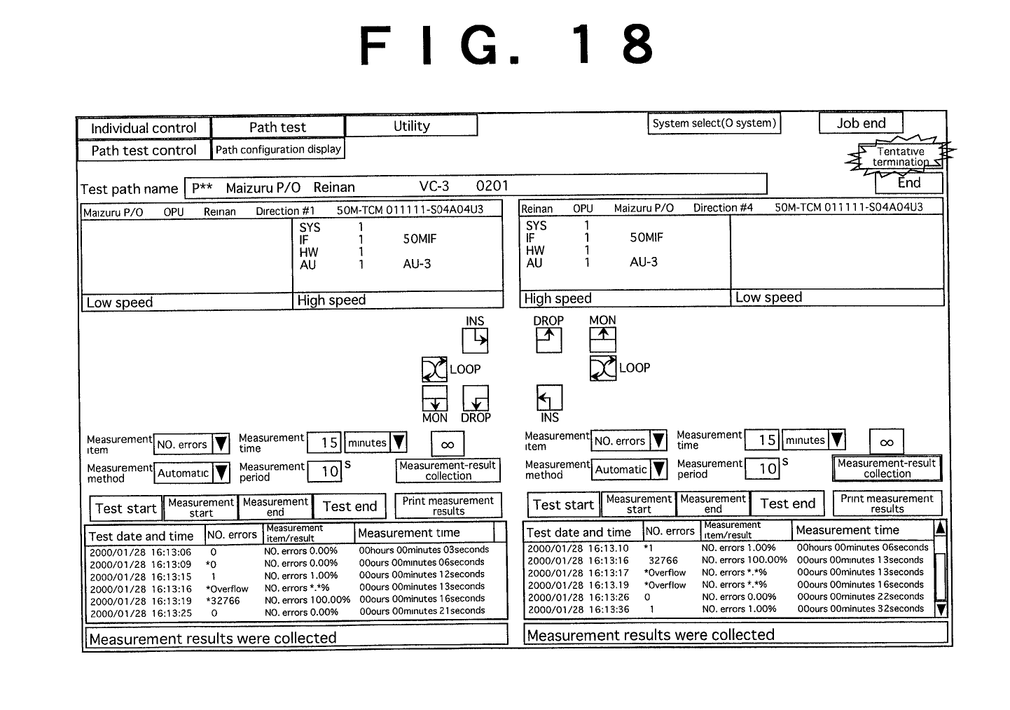

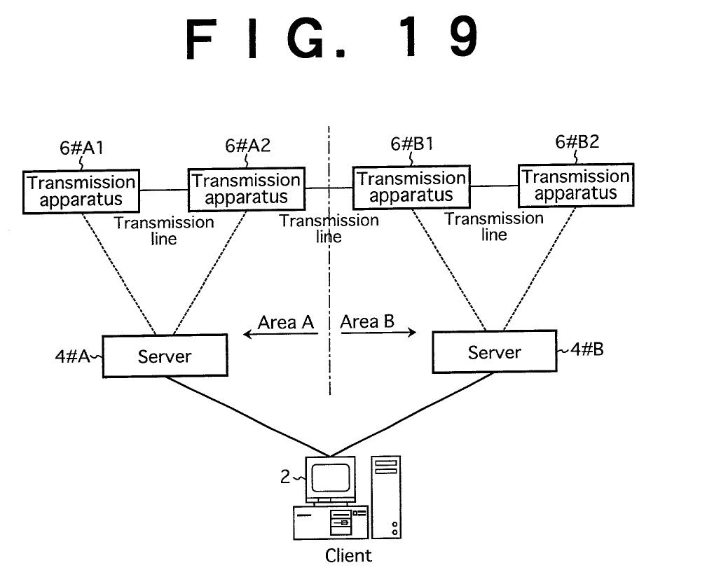

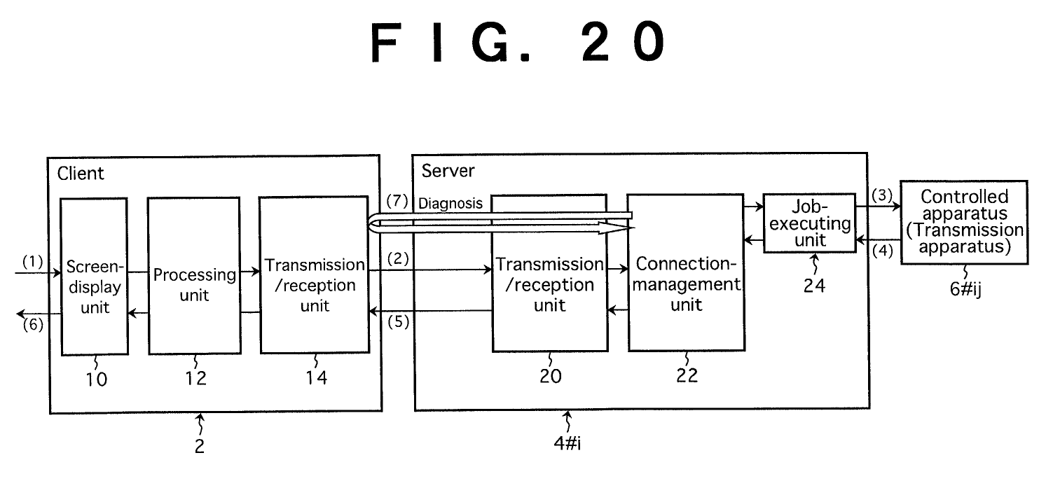

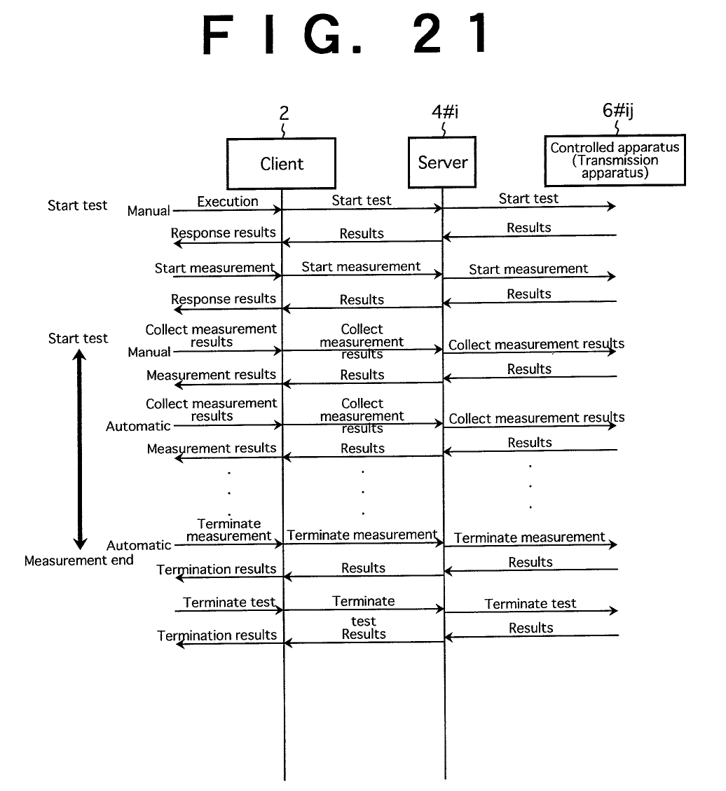

FIG. 17 is a diagram showing flows of processing to select an item from the list and FIG. 18 is a diagram showing a typical display screen showing the list. The operator operates an execution button after selecting an item from the list displayed on the resumption list screen shown in FIG. 16 as indicated by an arrow (145) shown in FIG. 14. When an item is selected from the list, the screen-display unit 70 requests the processing unit 72 to process a request for the item selected from the list as indicated by an arrow (220) shown in FIG. 17. The processing unit 72 creates a selected-list-item message including the item selected from the list and outputs the message to the transmission/reception unit 74 as indicated by an arrow (221) shown in FIG. 17. The transmission/reception unit 74 transmits the selected-list-item message to the server 62#i as indicated by an arrow (146) shown in FIG. 14 and an arrow (222) shown in FIG. 17. The transmission/reception unit 80 employed in the server 62#i passes on the selected-list-item message to the connection-management unit 82 as indicated by an arrow (223) shown in FIG. 17. The connection-management unit 82 requests the control-state-recovering unit 92 to read out all response data of the selected list item from the database 86 as indicated by an arrow (224) shown in FIG. 17. The control-state-recovering unit 92 makes an access to the database 86 in order to read out all response data of the selected list item from the database 86 as indicated by an arrow (225) shown in FIG. 17. Subsequently, the control-state-recovering unit 92 reads out all response data of the selected list item from the database 86 as indicated by an arrow (226) shown in FIG. 17. Then, the control-state-recovering unit 92 outputs the response data read out from the database 86 as recovered data to the connection-management unit 82 as indicated by an arrow (227) shown in FIG. 17. The connection-management unit 82 passes on the recovered data to the transmission/reception unit 80 as indicated by an arrow (228) shown in FIG. 17. The transmission/reception unit 80 transmits the recovered data to the client 60#i as indicated by an arrow (148) shown in FIG. 14 and an arrow (229) shown in FIG. 17. The transmission/reception unit 74 employed in the client 60#i passes on the recovered data to the processing unit 72 as indicated by an arrow (230) shown in FIG. 17. The processing unit 72 passes on the recovered data to the screen-display unit 70 as indicated by an arrow (231) shown in FIG. 17. The screen-display unit 70 displays the recovered data on a screen shown in FIG. 18 as indicated by an arrow (149) shown in FIG. 14.

<5-c> Resumption of Measurement-Result Collection

In order to resume collection of measurement results, the operator selects a measurement-result-collection item as indicated by an arrow (150) shown in FIG. 14 after verifying measurement results displayed on the screen and deciding to continue the collection of measurement results. The client 60#i transmits a measurement-result-collection message to the server 62#i as indicated by an arrow (151) shown in FIG. 14. The server 62#i transmits the received measurement-result-collection message to a transmission apparatus 16#ij as indicated by arrows (232) and (233) shown in FIG. 17 and an arrow (152) shown in FIG. 14. Receiving the measurement-result-collection message, the transmission apparatus 16#ij collects results of measurement and transmits the results to the server 62#i as indicated by an arrow (234) shown in FIG. 17 and an arrow (153) shown in FIG. 14. The server 62#i stores the received results of measurement in the database 86 as indicated by an arrow (154) shown in FIG. 14 as response data corresponding to status of measurement-result collection. Then, the server 62#i transmits the results of measurement to the client 60#i as indicated by an arrow (155) shown in FIG. 14. The client 60#i displays the results of measurement on a screen as indicated by an arrow (156) shown in FIG. 14. In this way, resumption of measurement-result collection can requested by the client 60#i. In the same way, for each period t of collection of measurement results, results of measurement are collected as indicated by arrows (157) to (162) shown in FIG. 14.

In order to terminate a measurement, the operator selects a measurement-termination item as indicated by an arrow (163) shown in FIG. 14. The client 60#i transmits a measurement-termination message to the server 62#i as indicated by an arrow (164) shown in FIG. 14. The server 62#i transmits the measurement-termination message to the transmission apparatus 16#ij as indicated by an arrow (166) shown in FIG. 14. Receiving the measurement-termination message, the transmission apparatus 16#ij terminates the measurement. The transmission apparatus 16#ij then transmits results to the server 62#i as indicated by an arrow (167) shown in FIG. 14. The server 62#i stores the results in the database 86 as indicated by an arrow (168) shown in FIG. 14. Then, the server 62#i transmits the results to the client 60#i as indicated by an arrow (169) shown in FIG. 14. The client 60#i displays the results on a screen as indicated by an arrow (170) shown in FIG. 14. The operator selects a test-termination item as indicated by an arrow (171) shown in FIG. 14. The client 60#i transmits a test-termination message to the server 62#i as indicated by an arrow (172) shown in FIG. 14. The server 62#i transmits the test-termination message to the transmission apparatus 16#ij as indicated by an arrow (173) shown in FIG. 14. Receiving the test-termination message, the transmission apparatus 16#ij terminates the measurement. The transmission apparatus 16#ij then transmits results to the server 62#i as indicated by an arrow (174) shown in FIG. 14. When receiving the results, the server 62#i deletes the data relevant to the test from the database 86 as indicated by an arrow (175) shown in FIG. 14. Then, the server 62#i transmits results to the client 60#i as indicated by an arrow (176) shown in FIG. 14. The client 60#i displays the results on a screen as indicated by an arrow (177) shown in FIG. 14.

<6> Normal Termination

Operations of a normal termination, which are carried out without a tentative termination, can be considered to be equivalent to a combination of the operations indicated by arrows (21) to (51) shown in FIG. 10 and the operations indicated by arrows (163) to (177) shown in FIG. 14, making it unnecessary to repeat their explanation.

The embodiment described above exhibits the following effects:

1: When a job is resumed after the screen of a specific client (terminal) is put in a tentative-termination state, the job can be resumed from a client (terminal) other than the specific client from which the job was carried out before the screen was put in the tentative-termination state, by carrying out a login operation at the other client which may be installed at another location. When a job is resumed, a login ID is checked to protect security of the job.

2: When the screen of a specific client (terminal) is put in a tentative-termination state, the server continues processing and stores results of the processing in a database. Thus, when the screen is opened again, the screen can be restored to a state reflecting the tentative-termination state so that the job can be resumed.

3: While the screen of a specific client (terminal) is in a tentative-termination state, the client can opens another control screen. That is to say, even if only one physical screen exists in the control terminal serving as the client, a plurality of jobs can be carried out.

4: Even if the screen of a client is terminated abnormally, the server is capable of detecting the abnormality and is capable of continuing the job processing. Also in this case, the screen can be restored in the same way as the above effect 2. Since restoration is possible, later processing (test termination) of the control job is also possible. Thus, there will be no longer a state in which the transmission apparatus involved in the control job remains involved in the control job as it does.

It should be noted that the present invention is not limited to the details of the preferred embodiments described above. The scope of the present invention is defined by the following appended claims, and all changes and modifications falling within the scope of the claims are therefore to be embraced by the invention.

What is claimed is:

1. A server for controlling a controlled apparatus, serving as a control object, in accordance with a request received from a client, said server comprising:
a database;
a control-state-saving unit for saving control information relevant to said request received from said client in said database;
a job-continuing unit for continuing a job of controlling said controlled apparatus on the basis of said control information, which is relevant to said request received from said client and is saved in said database;
a job-data-saving unit for saving response data received from said controlled apparatus as a result of said job-continued by said job-continuing unit in said database by associating said response data with said control information saved in said database; and
a data-recovering unit for creating a recovery message to be transmitted to said client on the basis of said control information, which is relevant to said request received from said client and is saved in said database, and on the basis of said response data saved in said database and associated with said control information.

2. A server according to claim 1, further comprising a connection-management unit for monitoring a state of connection between said server and said client, wherein, when said connection-management unit detects an abnormal state of connection between said server and said client, said job-continuing unit continues a job of controlling said controlled apparatus on the basis of said control information, which is relevant to said request received from said client and is saved in said database.

3. A server according to claim 2, wherein, when a request for a tentative termination is received from said client, said job-continuing unit continues a job of controlling said controlled apparatus on the basis of said control information, which is relevant to said request received from said client and is saved in said database.

4. A server according to claim 3, further comprising a status-saving unit for saving status indicating whether said response data is based on said abnormal state of connection between said server and said client or based on said request for a tentative termination.

5. A server according to claim 3, wherein:
said control information relevant to said request received from said client includes a first identifier;
said control-state-saving unit saves said first identifier in said database as part of said control information; and
said data-recovering unit creates a recovery message to be transmitted to a client on the basis of said control information, which is relevant to said request received from said client and is saved in said database, and on the basis of said response data saved in said database and associated with said control information when a request for a tentative termination is received from said client provided that a second identifier included in said request for a tentative termination matches said first identifier stored in said database as part of said control information.

6. A client-server system comprising a client and a server, wherein
said client comprises:
a test-control-requesting unit for transmitting control information relevant to test control to said server;
a tentative-termination-requesting unit for transmitting a request for a tentative termination of said test control to said server; and
a resumption-requesting unit for transmitting a request for a resumption of said test control to said server, whereas
said server comprises:
a database;
a control-state-saving unit for saving control information relevant to said request received from said client in said database;
a job-continuing unit for continuing a job of controlling a controlled apparatus, serving as a control object, on the basis of said control information, which is relevant to said request received from said client and is saved in said database;
a job-data-saving unit for saving response data received from said controlled apparatus as a result of said job continued by said job-continuing unit in said database by associating said response data with said control information saved in said database; and
a recovered-data-transmitting unit for creating a recovery message to be transmitted to said client on the basis of said control information, which is relevant to said request received from said client and is saved in said database, and on the basis of said response data saved in said database and associated with said control information.

7. A client-server system according to claim 6, wherein said server further comprises a connection-management unit for monitoring a state of connection between said server and said client, wherein, when said connection-management unit detects an abnormal state of connection between said server and said client, said job-continuing unit continues a job of controlling said controlled apparatus on the basis of said control information, which is relevant to said request received from said client and is saved in said database.

8. A client-server system according to claim 7, wherein said client further comprises a memory and a screen control unit for:
executing screen control relevant to said test control by using said memory; and
releasing said memory used for execution of said screen control at said request for a tentative termination.

9. A client-server system according to claim 7 wherein:
said client further comprises:
a list-requesting unit for requesting said server to transmit a list of test-control operations relevant to tentative terminations and relevant to connection abnormalities to said client;
a selected-item-requesting unit for selecting a test-control operation from said list received from said server and requesting said server to transmit response data related to said selected test-control operation to said client by providing said server with said selected test-control operation; and
a response-data-displaying unit for displaying said response data received from said server and related to said selected test-control operation, whereas
said server further includes:
a list-acquiring unit for acquiring information on test-control operations on said list from said database and transmitting said information to said client as requested by said client; and
a response-data-transmitting unit for acquiring response data related to said selected test-control operation provided by said client from said database and transmitting said response data to said client as requested by said client.
